(19) United States
(12) Patent Application Publication
(10) Pub. No.: US 2024/0228737 A1
(43) Pub. Date: Jul. 11, 2024

(54) DEPOLYMERIZATION OF POLYMERS WITH AMMONIA AND AMINES

(71) Applicant: Research Triangle Institute, Research Triangle Park, NC (US)

(72) Inventors: Ofei D. MANTE, Research Triangle Park, NC (US); Dennis GILMORE, Research Triangle Park, NC (US)

(21) Appl. No.: 18/559,068

(22) PCT Filed: May 10, 2022
(86) PCT No.: PCT/US22/28507

§ 371 Date: Nov. 6, 2023

Related U.S. Application Data
(60) Provisional application No. 63/188,869, filed on May 14, 2021.
(60) Provisional application No. 63/192,834, filed on May 25, 2021.

(51) Int. Cl. C08J 11/28; C08J 11/16

(52) U.S. Cl. CPC C08J 11/28; C08J 11/16; C08J 2377/00

(57) ABSTRACT

A process for depolymerizing a polymer comprises reacting the polymer with a nitrogen-containing compound in the presence of a catalyst whereby the polymer is depolymerized into one or more monomers. The catalyst comprises carbonate and an element in group 1 or group 2 of the periodic table. The nitrogen-containing compound comprises ammonia, an amine reagent, or a combination of ammonia and an amine reagent. The polymer comprises polyamide, polyester, polycarbonate, polyurethane, polybutylene terephthalate (PBT), polyethylene terephthalate (PET), lignocellulosic material, or combinations thereof.

### CROSS-REFERENCE TO RELATED APPLICATIONS

This application claims priority to U.S. Provisional Patent Application No. 63/188,869, filed on May 14, 2021, and U.S. Provisional Patent Application No. 63/192,834, filed on May 25, 2021, the entire contents of which are incorporated by reference herein.

### BACKGROUND OF THE INVENTION

Depolymerization of polyamides (PA) has been studied for many years and is of interest to many PA manufacturers. Conventionally, hydrolysis has been commercially used to depolymerize polycaprolactam (also referred to as Nylon 6 or PA6) into a caprolactam monomer. Ammonolysis, on the other hand, is promising for the recovery of monomers from PA6 and poly (hexamethylene adipamide) (also referred to as Nylon 66 or PA66), especially for mixed fractions. Current depolymerization processes work effectively with PA6 and mixtures of PA6 and PA66, but are not as effective for PA66 alone.

Current ammonolysis processing involves reacting PA with ammonia at relatively high temperatures (>300° C.) and elevated pressures (50-2,500 psig) in the presence of a catalyst. Lewis acids (e.g., Cu(I), Cu (II), Al₂O₃, SiO₂), Bronsted acids (H₃PO₄, BPO₄), and salts (NH₄H₂PO₄, NaNH₄HPO₄) have been used as catalysts for the reaction. The ammonolysis reaction is affected by processing conditions and the PA post-consumer waste stream.

A desirable monomer to recover from depolymerization of a PA66 or mixture of PA66 and PA6 is hexamethylenediamine (HMD). Depending on the ammonolysis process, other precusors to HMD such as adiponitrile and 6-aminocapronitrile are formed from mixtures of PA66 and PA6 feedstocks. Higher yields of HMD have also been achieved with mixtures having a higher concentration of PA6. Unfortunately, conventional ammonolysis reactions are slow and limited by equilibrium (once the acid is converted to nitrile, the water coproduced can trigger a reverse reaction to the amide). Further, contaminants present in the intermediates after PA depolymerization pose a challenge to downstream catalysis for monomer production.

### SUMMARY OF THE INVENTION

In a first aspect of the invention, a process for depolymerizing a polymer comprises reacting the polymer with a nitrogen-containing compound in the presence of a catalyst whereby the polymer is depolymerized into one or more monomers. In a feature of the aspect, the catalyst comprises carbonate and an element in group 1 or group 2 of the periodic table. For example, the catalyst comprises carbonate and one or more of elements Li, Na, K, Rb, Cs, Fr, Be, Mg, Ca, Sr, Ba, or Ra.

In a second aspect of the invention, a method of producing one or more monomers comprises reacting a polymer with a nitrogen-containing compound in the presence of a catalyst whereby the polymer is depolymerized into one or more monomers. In a feature of the aspect, the catalyst comprises carbonate and an element in group 1 or group 2 of the periodic table. For example, the catalyst comprises carbonate and one or more of elements Li, Na, K, Rb, Cs, Fr, Be, Mg, Ca, Sr, Ba, or Ra.

It is to be understood that both the foregoing general description of the invention and the following detailed description are exemplary but are not restrictive of the invention.

### BRIEF DESCRIPTION OF THE FIGURES

A more complete appreciation of the invention and many of the attendant advantages thereof will be readily obtained as the same becomes better understood by reference to the following detailed description when considered in connection with the accompanying drawings, wherein:

FIG. 1 is a schematic illustration of the evaluation of PA6 with a Rb₂CO₃ catalyst.

FIG. 2 is a GC-MS readout of the product stream.

FIG. 3 is a schematic illustration of the evaluation of pure PA66 with a Rb₂CO₃ catalyst.

FIG. 4 is a chart comparing the methanol soluble and insoluble yields for NH₄H₂PO₄ and Rb₂CO₃ catalysts.

FIG. 5 is a GC-MS analysis readout showing that the methanol-soluble fraction from the ammonolytic reaction of PA66 with Rb₂CO₃ contained primarily 1,6 hexamethylenediamine (52% of GC area) monomer and 1,8-diazacyclotetradecane-2,7-dione oligomer (28% of GC area).

FIG. 6 is an FT-IR readout showing the methanol-insoluble fraction of the ammonolytic reaction of PA66 with NH₄H₂PO₄ and Rb₂CO₃ catalysts.

FIG. 7 is a chart comparing the methanol soluble and insoluble yields for Al₂O₃ and Rb₂CO₃ catalysts.

FIG. 8 is a GC-MS readout of the methanol-soluble fraction from the ammonolytic reaction of the PA6/PA66 blend using the Rb₂CO₃ catalyst.

[symbol]

Error! Reference source not found.is a GC-chromatogram of the methanol soluble product from ammonolysis over HZSM-5.

[symbol]

Error! Reference source not found.is a GC-chromatogram of the methanol soluble product from ammonolysis over SiO₂/Al₂O₃.

[symbol]

Error! Reference source not found. is a GC-chromatogram of the methanol soluble product from ammonolysis over Ni— SiO₂/Al₂O₃ respectively.

### DETAILED DESCRIPTION OF THE INVENTION

Described herein is a process for depolymerization of a polymer by reacting the polymer with a nitrogen-containing compound, such as ammonia, a derivative of ammonia wherein one or more hydrogen atoms have been replaced by a substituent (also referred to as an amine reagent) or a combination of ammonia and an amine reagent, in the presence of a catalyst to produce one or more monomers.

Suitable polymers may comprise polyamide, polyester, polycarbonate, polyurethane, polybutylene terephthalate (PBT), polyethylene terephthalate (PET), lignocellulosic material, or combinations thereof. In embodiments, the polymer comprises a polyamide. Moreover, suitable polyamides may comprise aliphatic polyamides, such as poly(hexamethylene adipamide) (nylon 66); poly(hexamethylene sebacamide) (nylon 6,10); polycaprolactam (nylon 6); and poly(decamethylene carboxamide) (nylon 11), and aromatic polyamides such as poly(m-phenylene isophthalamide) (“Nomex”). In embodiments, the polyamide may comprise nylon 6 (PA6), nylon 66 (PA66) or a combination thereof.

The polymer is reacted with a nitrogen-containing compound, which may comprise ammonia, a derivative of ammonia wherein one or more hydrogen atoms have been replaced by a substituent (also referred to as an amine reagent) or a combination of ammonia and an amine reagent. The reaction of the polymer with ammonia is referred to herein as ammonolysis. The reaction of the polymer with an amine reagent is referred to herein as aminolysis. Ammonolysis may be combined with aminolysis to enhance monomer selectivity and depolymerization rate. In an exemplary embodiment, the diamine, HMD, which is a product of ammonolysis of PA66, can also be used as a reagent to break down PA polymers.

In an embodiment, the process described herein is a method of producing one or more monomers comprising reacting a polymer with a nitrogen-containing compound in the presence of a catalyst whereby the polymer is depolymerized into one or more monomers. The one or more monomers resulting from depolymerization of the polymer may comprise, 1,8-diazacyclotetradecane-2,7-dione, hexamethylenediamine (HMD), cyclopentanone, caprolactam, 1-undecanamine, other amines, amides, and diols (such as, ethylene diol or butylene diol) or combinations thereof. The identification of the monomers and the content of each monomer in the recovered monomer mixture can be determined by quantitative gas-liquid chromatography. The process can be performed as a batch or continuous process.

The depolymerization catalyst may comprise carbonate and an element in group 1 or group 2 of the periodic table (also referred to herein as a carbonate catalyst). For example, the catalyst may comprise carbonate and one or more elements Li, Na, K, Rb, Cs, Fr, Be, Mg, Ca, Sr, Ba, or Ra. In an embodiment, the catalyst comprises Rb₂CO₃. In another embodiment, the catalyst may comprise one or more of Rb₂CO₃, Rh(PPh₃)₃Cl, Rh(OH)₃, Rh₂(CO₃)₃, Rh₂(COD)₂Cl₂, 5% Rh/CdCO₃, 5% Rh/ZnCO₃, 5% Rh/CoCO₃, 5% Rh/NiCO₃. Catalysts comprising carbonate catalyst compounds have been shown to enhance the rate of depolymerization of PA over conventionally used catalysts at relatively low temperatures (<300° C.).

In an embodiment, the claimed process comprises depolymerization of one or more polyamides by reacting the polyamide with ammonia to produce one or more monomers, such as, for example, caprolactam, hexamethylenediamine (HMD), and 1,8-diazacyclotetradecane-2,7-dione. Depolymerization of polyesters, such as polyethylene terephthalate (PET), results in the formation of amide and diol (ethylene diol or butylene diol) monomers.

The depolymerization process described herein takes place at a relatively lower temperature, which is less than or equal to 300° C. For example, the depolymerization process may take place at a temperature of about 200° C. to about 300° C., including temperatures of 210° C., 220° C., 230° C., 240° C., 250° C., 260° C., 270° C., 275° C., 280° C., 285° C., 290° C., 295° C. and 300° C. The depolymerization process described herein takes place at a relatively lower pressure, which is less than or equal to about 500 psig, including pressures of about 200 psig, 250 psig, 300 psig, 350 psig, 400 psig, 450 psig and 500 psig. The process enables a relatively high rate of depolymerization at a relatively lower temperature (up to 300° C.) and pressure (up to 1000 psig).

In an exemplary embodiment, a continuous process using a fluidized bed reactor operating at moderate pressures wherein ammonia and polyamide feedstock are fed continuously can enhance the depolymerization process. The approach provides processing advantages, such as effective heat and mass transfer, relatively low reaction temperature, and the ability to recover and regenerate the catalyst.

For example, a mixed polymer feed containing 30 wt % PA6, 30 wt % PA66, and 40 wt % polypropylene (PP) was depolymerized at 400° C. by catalytic pyrolysis over gamma-Al₂O₃ in a fluidized bed reactor. The composition of the liquid/wax intermediate recovered from the reactor after pyrolysis included various nitrogenous compounds (caprolactam, nitriles, amines, heterocyclics), ketones (cyclopentanones and diones), and hydrocarbons (primarily cyclic alkanes and olefins).

In embodiments, the polymer to be depolymerized can be prepared using a polymerization precursor. For example, the monomer, 8-diazacyclotetradecane-2,7-dione can be a polymerization precursor for PA66. In this example, polymerization of 8-diazacyclotetradecane-2,7-dione can be initiated by reacting it with a small amount of HMD.

The depolymerization process described herein advances the ammonolysis process to enable the efficient recovery of valuable monomers from post-consumer materials destined for landfills. The described depolymerization process can reduce energy input in the synthesis of polyamides and be competitive with virgin material.

In embodiments, the depolymerization process catalyzed by a basic catalyst can promote selective ammonolytic depolymerization of PA66 into the valuable monomer HMD with the formation of cyclopentanone. Without being bound by theory, this result indicates that basic catalysts promote a different ammonolytic mechanism compared to Lewis's acid catalysts. Typically, ammonolysis promoted by Lewis acids undergoes amide link cleavage and amide end dehydration. The amide link cleavage leads to an amine and an amide end group that subsequently dehydrates to form nitrile end groups. Thus, the acidic-based ammonolysis process leads to the formation of amines, amides, and nitriles. Additionally, studies show that acidic catalyzed ammonolysis reactions are limited by equilibrium. Thus, lower yields of HMD and other valuable monomers are usually realized for PA66.

For the described depolymerization process catalyzed by a basic catalyst, the reaction mechanisms are not understood, but the test results indicate that the basic catalysts deconstruct PA66 into its cyclic monomer (1,8-diazacycltetradecane-2,7-dione), which subsequently breaks to form HMD; and cyclopentanone is formed as a result of ketonic decarboxylation of adipic acid. Thus, the process can be optimized (temperature, ammonia pressure, and feed-to-catalyst ratio) to recover quantitatively the original HMD monomer used in the synthesis of the PA66 polymer and adipic acid recovered as cyclopentanone. Thus, the product slate from the developed basic catalyzed ammonolysis is less chemically complex allowing for relatively easy separation of HMD without any further downstream processing. In contrast, the acidic catalyzed process leads to the formation of several species including amines, amides, and nitriles.

While the following terms are believed to be well understood by one of ordinary skill in the art, the following definitions are set forth to facilitate explanation of the presently disclosed subject matter.

Throughout the present specification, the terms “about” and/or “approximately” may be used in conjunction with numerical values and/or ranges. The term “about” is understood to mean those values near to a recited value. For example, “about 40 [units]” may mean within ±25% of 40 (e.g., from 30 to 50), within ±20%, ±15%, ±10%, ±9%, ±8%, ±7%, ±6%, ±5%, ±4%, ±3%, ±2%, ±1%, less than ±1%, or any other value or range of values therein or there below. Furthermore, the phrases “less than about [a value]” or “greater than about [a value]” should be understood in view of the definition of the term “about” provided herein. The terms “about” and “approximately” may be used interchangeably.

Throughout the present specification, numerical ranges are provided for certain quantities. It is to be understood that these ranges comprise all subranges therein. Thus, the range “from 50 to 80” includes all possible ranges therein (e.g., 51-79, 52-78, 53-77, 54-76, 55-75, 60-70, etc.). Furthermore, all values within a given range may be an endpoint for the range encompassed thereby (e.g., the range 50-80 includes the ranges with endpoints such as 55-80, 50-75, etc.).

As used herein, the verb “comprise” as is used in this description and in the claims and its conjugations are used in its non-limiting sense to mean that items following the word are included, but items not specifically mentioned are not excluded. Throughout the specification the word “comprising,” or variations such as “comprises” or “comprising,” will be understood to imply the inclusion of a stated element, integer or step, or group of elements, integers or steps, but not the exclusion of any other element, integer or step, or group of elements, integers or steps. The present disclosure may suitably “comprise”, “consist of”, or “consist essentially of”, the steps, elements, and/or reagents described in the claims.

It is further noted that the claims may be drafted to exclude any optional element. As such, this statement is intended to serve as antecedent basis for use of such exclusive terminology as “solely”, “only” and the like in connection with the recitation of claim elements, or the use of a “negative” limitation.

Unless defined otherwise, all technical and scientific terms used herein have the same meanings as commonly understood by one of ordinary skill in the art to which this disclosure belongs. Preferred methods, devices, and materials are described, although any methods and materials similar or equivalent to those described herein can be used in the practice or testing of the present disclosure. All references cited herein are incorporated by reference in their entirety.

The following Examples further illustrate the disclosure and are not intended to limit the scope. It is to be understood that this disclosure is not limited to embodiments described. It is also to be understood that the terminology used herein is for the purpose of describing embodiments only, and is not intended to be limiting, since the scope of the present disclosure will be limited only by the appended claims.

### EXAMPLES

### Example 1. Comparison of Carbonate Catalyst to Conventionally Used Depolymerization Catalysts

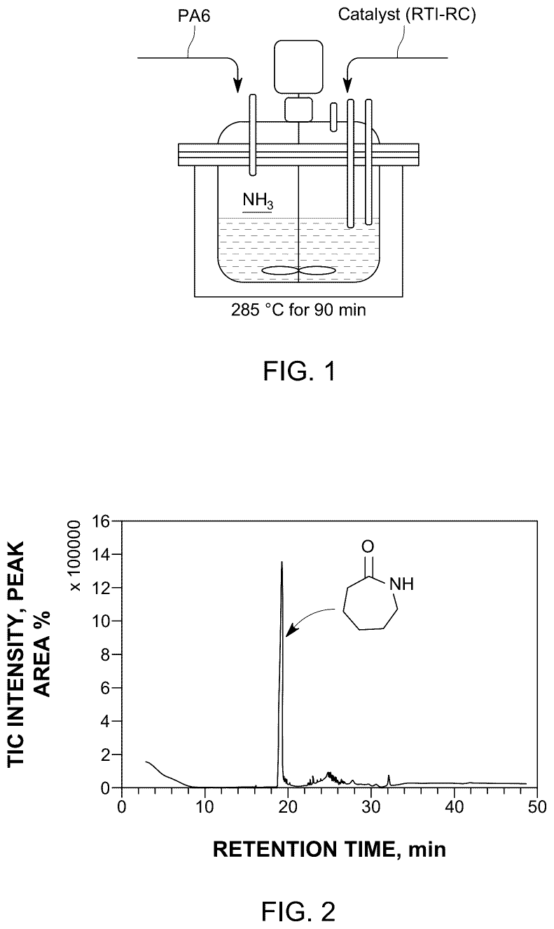

The performance of an exemplary embodiment of a carbonate catalyst was evaluated in comparison to a phosphate salt (NH₄H₂PO₄) and Al₂O₃ catalysts, both of which have conventionally been used for the ammonolysis of PAs. FIG. 1 is a schematic illustration of the evaluation of PA6 with a Rb₂CO₃ catalyst. The experiments were performed in a batch reactor at 285° C. and 500 psig for 90 minutes. PA6, PA66, and a mixture of PA6 and PA66 were evaluated at a feed-to-catalyst ratio of 3. Anhydrous ammonia was used first to pressurize the reactor to 75 psig, then 10% NH₃/He was used to pressurize the reactor to 500 psig. The reactor was heated to 285° C. for 90 minutes. The reaction products were washed with methanol, and solid products were filtered out. Pure PA6 was depolymerized using a Rb₂CO₃ catalyst at 285° C. and 500 psig for 90 minutes. PA6 was completely depolymerized and only methanol-soluble products were recovered (near 100 wt %). FIG. 2 is a GC-MS readout of the product stream. As shown, the product stream contained over 80% of the PA6 monomer caprolactam.

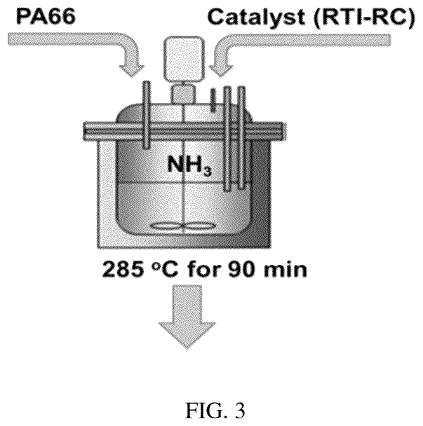

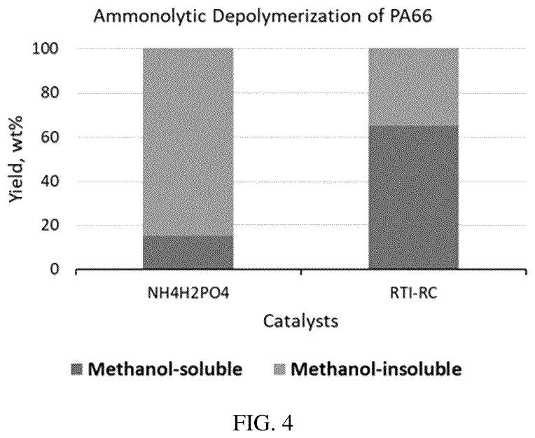

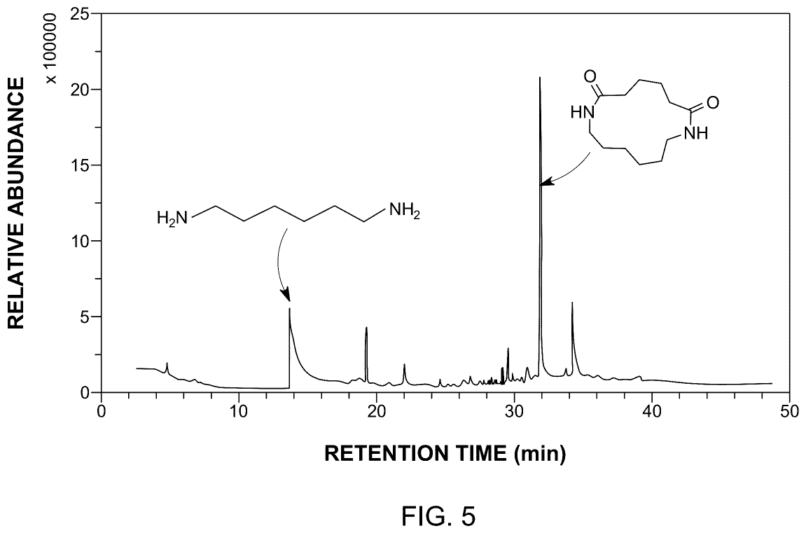

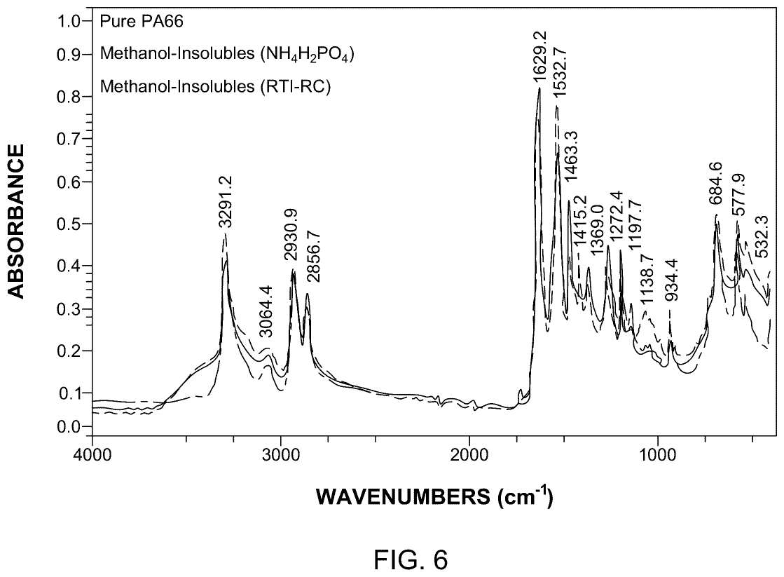

FIG. 3 is a schematic illustration of the evaluation of pure PA66 with a Rb₂CO₃ catalyst. The ammonolytic reaction of PA66 using a Rb₂CO₃ catalyst resulted in 65 wt % methanol-soluble product. In contrast, the reaction of PA66 using a NH₄H₂PO₄ catalyst resulted in only 15 wt % methanol-soluble product. FIG. 4 is a chart comparing the methanol soluble and insoluble yields for NH₄H₂PO₄ and Rb₂CO₃ catalysts. FIG. 5 is a GC-MS analysis readout showing that the methanol-soluble fraction from the ammonolytic reaction of PA66 with Rb₂CO₃ contained primarily 1,6 hexamethylenediamine (52% of GC area) monomer and 1,8-diazacyclotetradecane-2,7-dione oligomer (28% of GC area). FIG. 6 is an FT-IR readout showing the methanol-insoluble fraction of the ammonolytic reaction of PA66 with NH₄H₂PO₄ and Rb₂CO₃ catalysts. The FT-IR analysis indicated that the methanol-insoluble fraction from both tests was undegraded PA66 material; implying that the Rb₂CO₃ catalyst degraded 65% of the PA66 material compared to 15% when NH₄H₂PO₄ was used at the same conditions. This result shows that the Rb₂CO₃ catalyst enhanced the rate of depolymerization compared to the NH₄H₂PO₄ catalyst, which is currently commercially used.

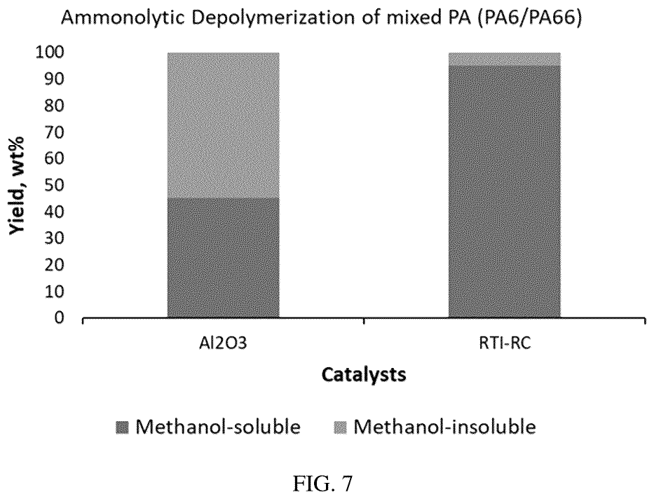

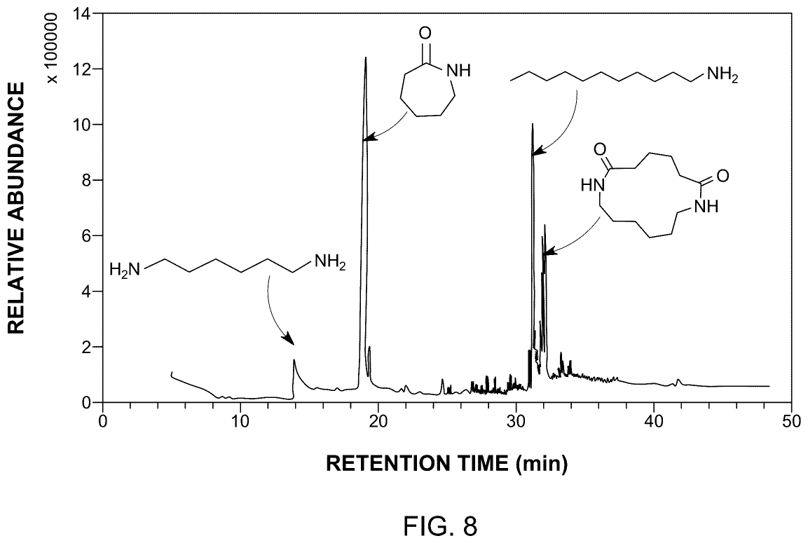

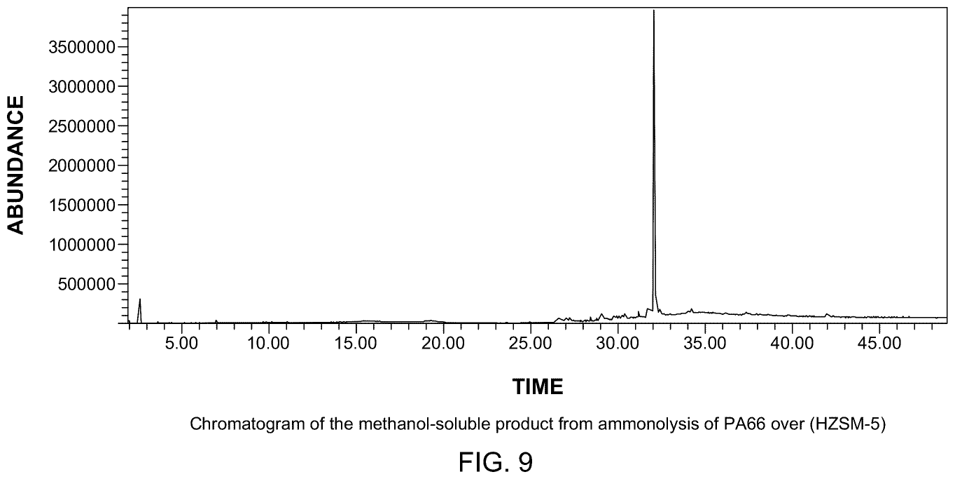

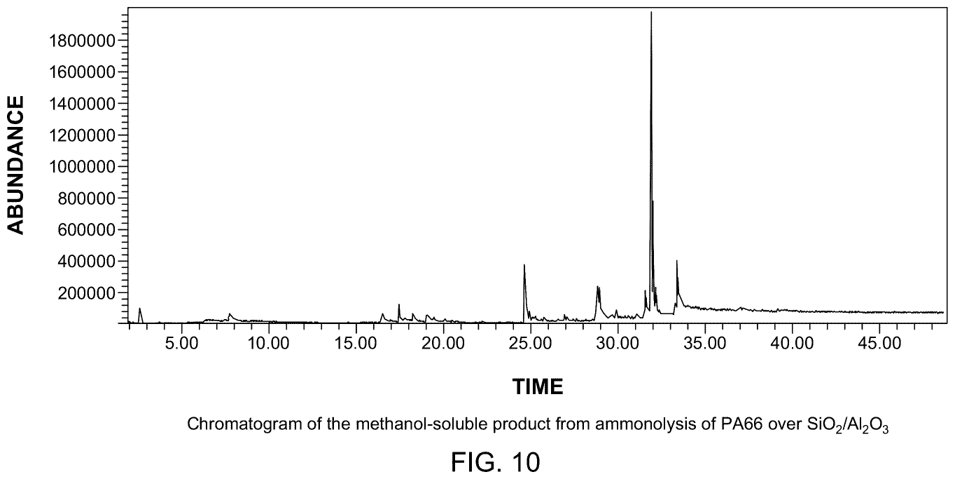

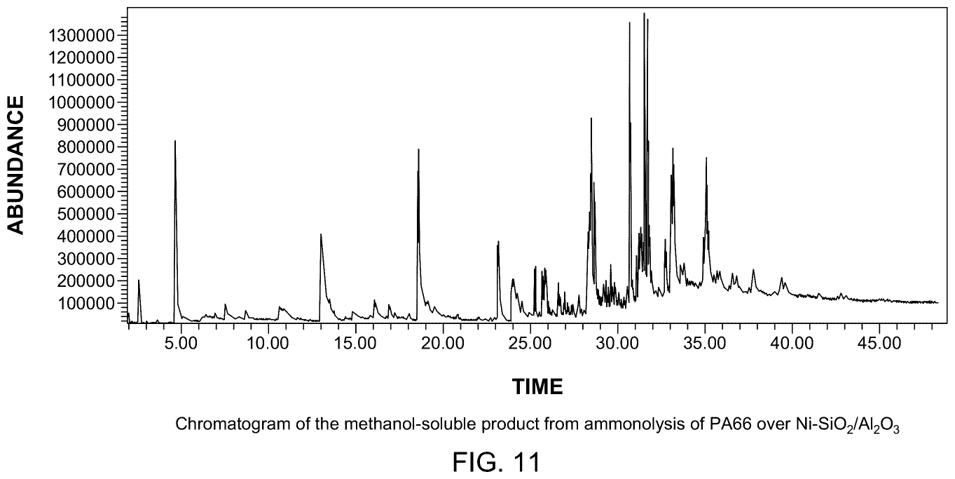

Ammonolytic depolymerization of a 50/50 by weight mixture of PA6 and PA66 at 285° C. and 500 psig was performed for 90 minutes. The performance of a Rb₂CO₃ catalyst was compared with an Al₂O₃ catalyst. The reaction products were collected as methanol-soluble and insoluble. FIG. 7 is a chart comparing the methanol soluble and insoluble yields for Al₂O₃ and Rb₂CO₃ catalysts. The results showed that generally depolymerization of the PA blend (PA6/PA66) resulted in higher depolymerized products in comparison to depolymerizing pure, non-mixed PA66. As with PA6, the Rb₂CO₃ catalyst provided the highest methanol-soluble product yield (95 wt %). In comparison, the Al₂O₃ catalyst gave methanol-soluble yields of 45 wt %. FIG. 8 is a GC-MS readout of the methanol-soluble fraction from the ammonolytic reaction of the PA6/PA66 blend using the Rb₂CO₃ catalyst. The GC-MS analysis showed that the depolymerized products in the methanol fraction were primarily caprolactam, 1,6 hexamethylenediamine, 1-undecanamine, and 1,8-diazacyclotetradecane-2,7-dione oligomer. As shown, the Rb₂CO₃ catalyst could depolymerize a blend of PA6 and PA66 into various monomers. The concentration of caprolactam in the methanol-soluble product was remarkably high, suggesting that ammonolysis of the PA6 fraction occurred readily and selectively. The amine, diamines, 8-diazacyclotetradecane-2,7-dione oligomer, and other unidentified compounds in the methanol-soluble product were from depolymerization of the PA66 fraction.

In the above-described evaluation, the Rb₂CO₃ catalysts performed better in ammonolysis of PAs than the state of technology catalysts tested at the low temperature and pressure conditions used.

### Example 2. Comparison of Carbonate Catalyst to Conventionally Used Depolymerization Catalysts

The performance of the basic catalyst (Rb₂CO₃) was compared with other catalysts including solid acid catalysts (HZSM-5), SiO₂/Al₂O₃, and Ni— SiO₂/Al₂O₃. The ammonolysis reactions were performed in a batch reactor at 290° C. and 500 psig for 90 minutes. The PA66 was evaluated at a feed-to-catalyst ratio of 3. Anhydrous ammonia was used first to pressurize the reactor to 80 psig, then 10% NH₃/He was used to pressurize the reactor to 500 psig. The reactor was heated to 290° C. for 90 minutes. The products were recovered as methanol-soluble and methanol-insoluble. The high yield of methanol-insoluble products was an indication of low depolymerization of PA66 at the conditions studied. [symbol] Error! Reference source not found. [symbol] Error! Reference source not found., and [symbol] Error! Reference source not found. show the GC-chromatogram of the methanol soluble product from ammonolysis over HZSM-5, SiO₂/Al₂O₃, and Ni— SiO₂/Al₂O₃, respectively.

The ammonolysis over HZSM-5 was very ineffective. The methanol-insoluble yield was 94 wt %, implying the HZSM-5 was unable to depolymerize PA66 ammonolytically at the conditions used. No formation of HMD precursors (amides and nitriles) and cyclopentanone were observed in the methanol-soluble fraction. The reaction with SiO₂/Al₂O₃ was also less effective, the methanol-insoluble fraction was 87 wt %. The methanol-soluble fraction showed a myriad of decomposition species including hexamethylenimine, derivatives of HMD, caprolactam, cyclopenedione, cyclopentanamine. Again, no peak of cyclopentanone was observed. The ammonolysis over Ni— SiO₂/Al₂O₃ showed a very high depolymerization rate; the methanol-insoluble fraction was 26 wt %. This is even lower than the methanol-insoluble yield obtained from Rb₂CO₃. The methanol-soluble fraction contained many different species including amides (e.g., pentanamide, propenamide, butanamide, adipamide, pentamide, valeramide, hexanamide), nitriles (e.g., pentanenitrile, hexanenitrile), aniline, pyridine caprolactam and ketones (e.g., 2-cyclohexen-1-one, cycloheptanone).

1. A process for depolymerizing a polymer comprising reacting the polymer with a nitrogen-containing compound in the presence of a catalyst whereby the polymer is depolymerized into one or more monomers.

2. The process of claim 1, wherein the catalyst comprises carbonate and an element in group 1 or group 2 of the periodic table.

3. The process of claim 2, wherein the catalyst comprises carbonate and one or more of elements Li, Na, K, Rb, Cs, Fr, Be, Mg, Ca, Sr, Ba, or Ra.

4. The process of claim 2, wherein the catalyst comprises Rb₂CO₃.

5. The process of claim 1, wherein the catalyst comprises one or more of Rb₂CO₃, Rh(PPh₃)₃Cl, Rh(OH)₃, Rh₂(CO₃)₃, Rh₂(COD)₂Cl₂, 5% Rh/CdCO₃, 5% Rh/ZnCO₃, 5% Rh/CoCO₃, 5% Rh/NiCO₃.

6. The process of claim 1, wherein the nitrogen-containing compound comprises ammonia, a derivative of ammonia wherein one or more hydrogen atoms have been replaced by a substituent (an amine reagent), or a combination of ammonia and an amine reagent.

7. The process of claim 1, wherein the polymer comprises a polyamide, polyester, polycarbonate, polyurethane, polybutylene terephthalate (PBT), polyethylene terephthalate (PET), lignocellulosic material or combinations thereof.

8. (canceled)

9. (canceled)

10. The process of claim 1, wherein the one or more monomers comprise caprolactam, hexamethylenediamine (HMD), 1,8-diazacyclotetradecane-2,7-dione, 1-undecanamine, diols (such as, ethylene diol or butylene diol) or combinations thereof.

11. The process of claim 1, wherein depolymerizing takes place at a temperature less than or equal to 300° C. and at a pressure less than or equal to 500 psig.

12. The process of claim 1, wherein the process is a batch process or a continuous process.

13. (canceled)

14. (canceled)

15. The process of claim 1, further comprising preparing the polymer to be depolymerized by reacting a polymerization precursor with a reagent.

16. (canceled)

17. (canceled)

18. A method of producing one or more monomers comprising reacting a polymer with a nitrogen-containing compound in the presence of a catalyst whereby the polymer is depolymerized into one or more monomers.

19. The process of claim 18, wherein the catalyst comprises carbonate and an element in group 1 or group 2 of the periodic table.

20. (canceled)

21. (canceled)

22. The process of claim 18, wherein the catalyst comprises one or more of Rb₂CO₃, Rh(PPh₃)₃Cl, Rh(OH)₃, Rh₂(CO₃)₃, Rh₂(COD)₂Cl₂, 5% Rh/CdCO₃, 5% Rh/ZnCO₃, 5% Rh/CoCO₃, 5% Rh/NiCO₃.

23. The process of claim 18, wherein the nitrogen-containing compound comprises ammonia, a derivative of ammonia wherein one or more hydrogen atoms have been replaced by a substituent (an amine reagent), or a combination of ammonia and an amine reagent.

24. The process of claim 18, wherein the polymer comprises a polyamide, polyester, polycarbonate, polyurethane, polybutylene terephthalate (PBT), polyethylene terephthalate (PET), lignocellulosic material or combinations thereof.

25. (canceled)

26. (canceled)

27. The process of claim 18, wherein the one or more monomers comprise caprolactam, hexamethylenediamine (HMD), 1,8-diazacyclotetradecane-2,7-dione, 1-undecanamine, amides, diols (such as ethylene diol or butylene diol), or combinations thereof.

28. The process of claim 18, wherein depolymerizing takes place at a temperature less than 300° C. and at a pressure less than or equal to 500 psig.

29. The process of claim 18, wherein the process is a batch process or a continuous process.

30. (canceled)

31. (canceled)

32. The process of claim 18, further comprising preparing the polymer to be depolymerized by reacting a polymerization precursor with a reagent.

33. (canceled)

34. (canceled)
